(19) United States
(12) Patent Application Publication
(10) Pub. No.: US 2023/0336348 A1
(43) Pub. Date: Oct. 19, 2023

(54) NFT GENERATION METHOD AND SYSTEM FOR NON-DIGITAL ASSETS

(71) Applicant: SAMSUNG SDS CO., LTD., Seoul (KR)

(72) Inventors: Kwan Sik YOON, Seoul (KR); Eun Kyung KIM, Seoul (KR)

(73) Assignee: SAMSUNG SDS CO., LTD., Seoul (KR)

(21) Appl. No.: 17/957,861

(22) Filed: Sep. 30, 2022

(30) Foreign Application Priority Data
Apr. 14, 2022 (KR) 10-2022-0046173

(51) Int. Cl. H04L 9/32; G06V 10/764

(52) U.S. Cl. CPC H04L 9/3213; H04L 9/3263; H04L 9/3236; G06V 10/764; H04L 2209/60

(57) ABSTRACT

Methods performed by a computing device for generating Non-Fungible Token (NFT) for a non-digital asset are provided. One of the methods comprises receiving non-digital asset data including media data generated by photographing non-digital asset and additional information, determining whether the media data is generated by photographing a tangible subject, automatically generating an original certificate of non-digital asset data including a result of whether the tangible subject is photographed and the media data, and issuing an NFT for the original certificate.

This application claims the benefit of Korean Patent Application No. 10-2022-0046173, filed on Apr. 14, 2022, in the Korean Intellectual Property Office, the disclosure of which is incorporated herein by reference in its entirety.

### BACKGROUND

### 1. Technical Field

The present disclosure relates to a Non-Fungible Token (NFT) issuance for non-digital assets and system thereof. More specifically, it is to present a method for converting non-digital assets to digital assets and to prove that a specific user group is the owner of the asset through digital signatures.

### 2. Description of the Related Art

An NFT is an abbreviation for Non-Fungible Token. It means a digital asset in that each token is assigned a unique value to distinguish it from other tokens, and the history of changes such as generation, transfer, and extinction is recorded in the blockchain network.

Conventional NFT (Non Fungible Token) technology was able to issue reliable NFT only for digital assets. The issuance of NFTs for existing non-digital assets had difficulties in determining and proving whether the assets are real since they are proved for the originals based on fairly limited information.

In addition, in the case of NFT issuance and transaction proof for existing digital assets, there is a problem in that it is difficult to prove and identify the original according to the existing digital signature method when the ownership of the asset is plural.

Therefore, the original proof technology that can more accurately verify the possibility of forgery/falsification of non-digital assets and determine whether images contained in data are tangible or processed subjects are required, and proof of ownership are required when there are a plurality of owners for the non-digital assets.

### RELATED ART

Korean Patent Publication No. 10-2022-0017621 (issued on Feb. 14, 2022)

### SUMMARY

A technical problem to be solved by the present disclosure is to provide a method and apparatus for issuing and managing NFTs for non-digital assets.

Other technical problem to be solved by the present disclosure is to provide a method for converting non-digital assets into digital assets.

Another technical problem to be solved by the present disclosure is to provide a digital signature method and apparatus in the case where there are a plurality of owners of non-digital assets.

Still another technical problem to be solved by the present disclosure is to provide a method and system for issuing and managing an NFT that ensures the reliability of NFT transactions by accurately verifying whether an NFT generated based on non-digital assets is original.

Still another technical problem to be solved by the present disclosure is to provide a method and system for issuing and managing an NFT that enables transactions based on NFT technology by converting non-digital assets into a plurality of tokens.

The technical problems of the present disclosure are not limited to the technical problems mentioned above, and other technical problems not mentioned will be clearly understood by those skilled in the art from the description below.

According to the present disclosure, a method for generating an NFT for non-digital asset performed by a computing device is provided. The method comprises, receiving non-digital asset data comprising additional information and media data generated by photographing the non-digital asset, determining whether the media data is generated by photographing a tangible subject, automatically generating an original certificate of non-digital asset data, the original certificate comprising the media data and a result of the determining of whether the media data is generated by photographing the tangible subject and issuing an NFT (Non-Fungible Token) for the original certificate.

In some embodiments, the media data is generated by operations may comprises, obtaining a screen division value for photographing the non-digital asset, classifying a photographing screen into a plurality of sections based on the screen division value, photographing a first image by focusing on a first section among the plurality of sections, photographing a second image by focusing on a second section among the plurality of sections and storing the first image and the second image as the media data.

In some embodiments, the determining whether the media data is generated by photographing a tangible subject may comprises, obtaining a screen division value related to an image of the non-digital asset, identifying focused sections of the first image and the second image with reference to the screen division value and determining whether the media data is an image of photographing a tangible subject based on a result of identifying the focused sections.

In some embodiments, the determining whether the media data is generated by photographing a tangible subject may comprises, obtaining a screen division value related to an image of the non-digital asset, identifying focused sections of the first image and the second image with reference to the screen division value and determining whether the media data is an image of photographing a tangible subject based on a result of identifying the focused sections.

In some embodiments, the automatically generating the original certificate comprises, converting the additional information into a standard format, generating hash data of the media data and generating hash data of the original certificate using hash data of the media data and additional information converted into the standard format.

In some embodiments, the issuing an NFT for the original certificate may comprises, issuing an NFT for the original certificate using hash data of the original certificate.

In some embodiments, the automatically generating the original certificate may comprises, sending a digital signature request to each terminal of a plurality of owners included in the additional information, receiving signature data from each terminal of the plurality of owners, generating one collective signature data using each of the received signature data and digitally signing the original certificate using the collective signature data, wherein issuing an NFT for the original certificate comprises, issuing an NFT for the digitally signed original certificate.

In some embodiments, the sending the digital signature request may comprises, sending a digital signature request including hash data of the automatically generated original certificate.

In some embodiments, the method may further comprises, verifying the signed original certificate, wherein verifying the signed original certificate comprises, if there are a plurality of owners of the non-digital asset, extracting a plurality of public keys of the plurality of owners in response to a verification key provision request, generating a single verification key based on the plurality of public keys.

In some embodiments, the plurality of public keys may correspond to a plurality of secret keys of the plurality of owners, wherein the single verification key is used to verify a signed original certificate.

In some embodiments, the automatically generating the original certificate may comprises, receiving digital signature data for the original certificate from a terminal of an owner, using the digital signature data to generate a digitally signed original certificate, generating hash data of the digitally signed original certificate and automatically storing the digitally signed original certificate in a cloud storage, and obtaining an access path to the digitally signed original certificate from the cloud storage.

In some embodiments, the issuing an NFT for the original certificate may comprises, using hash data of the original certificate and the access path to generate a blockchain transaction for issuing an NFT.

According to another aspect of the present disclosure, a computing device may comprises, one or more processors, a memory configured to load a computer program executed by the processor and a storage configured to store the computer program, wherein the computer program comprises instructions for performing operations of: receiving non-digital asset data including media data generated by photographing non-digital asset and additional information, determining whether the media data is generated by photographing a tangible subject, automatically generating an original certificate of non-digital asset data including a result of whether the tangible subject is photographed and the media data and issuing an NFT (Non-Fungible Token) for the original certificate.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a system for generating NFTs for non-digital assets according to embodiments of the present disclosure;

FIG. 2 is a flowchart of a method for issuing NFTs for non-digital assets according to another embodiment of the present disclosure;

FIGS. 3 to 6 are detailed flowcharts for describing in detail some operations of the method for issuing NFTs for non-digital assets described with reference to FIG. 2;

FIG. 7 is a flowchart illustrating a method of verifying a signed original certificate according to another embodiment of the present disclosure;

FIG. 8 is a detailed flowchart for describing in detail the method of verifying the NFT generated for the non-digital asset described with reference to FIG. 7;

FIG. 9 is a diagram for describing an exemplary layout of an original certificate that may be automatically generated in some embodiments of the present disclosure;

FIG. 10 is a diagram for further describing operations S2331a to S2334a of operation S2330 of FIG. 5;

FIG. 11 is a diagram for further describing operation S2500 of FIG. 8;

FIG. 12 is a diagram for conceptually describing a method for photographing and determining an image based on a tangible subject discrimination algorithm of the present disclosure;

FIG. 13 is a block diagram illustrating a detailed method of photographing a multi-focus image through the photographing device and the determining device shown in FIG. 12 and determining whether the image is a tangible subject image based thereon;

FIG. 14 is a diagram for describing in detail the multi-focus image mentioned in FIG. 13 and a photographing method thereof;

FIG. 15 is a view for describing examples of screen classification according to various screen division values by giving specific examples;

FIG. 16 is a view for describing examples of setting a photographing order according to various order values with specific examples;

FIG. 17 is a view for describing an embodiment, in which the image photographing method according to the present disclosure is applied in units of pixels.

FIG. 18 is a flowchart illustrating an image photographing method according to an embodiment of the present disclosure;

FIG. 19 is a flowchart illustrating an image determining method according to an embodiment of the present disclosure;

FIG. 20 is a flowchart illustrating an embodiment, in which the operation of determining the type of the image of FIG. 19 is further detailed.

FIG. 21 is a schematic diagram for describing an original proof method according to embodiments of the present disclosure.

FIG. 22 is a flowchart illustrating an original proof method according to an embodiment of the present disclosure;

FIG. 23 is a diagram for further describing operation S110 of FIG. 22;

FIG. 24 is a flowchart illustrating operation S120 of FIG. 23;

FIG. 25 is a flowchart illustrating an embodiment of operation S121 of FIG. 24;

FIG. 26 is a flowchart illustrating operation S130 of FIG. 22;

FIG. 27 is a flowchart illustrating an original proof method according to another embodiment of the present disclosure;

FIG. 28 is a flowchart illustrating an original proof method according to another embodiment of the present disclosure;

FIGS. 29 and 30 are diagrams for further describing operation S310 of FIG. 28;

FIG. 31 is a block diagram illustrating exemplary components of a key management server; and

FIG. 32 is a block diagram illustrating an exemplary hardware configuration of a computing device, in which various embodiments of the present disclosure are implemented.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Before describing some embodiments, the meaning of some terms mentioned in the present disclosure will be described.

A non-digital asset means a real thing with a physical substance. For example, the non-digital asset may be understood as a concept including all types of tangible subjects whose asset value can be recognized, such as art works such as paintings, prints, sculptures, or limited edition products.

Media data means content created as a result of photographing the non-digital asset. For example, the media data may be a photo, a moving picture, an animation, smell information, a sound, or a hologram. In addition, the media data may further include metadata about the content. For example, the media data may further include metadata such as a photographing time, a photographing position, and a lens. In addition, the media data may further include analysis result data for the content.

The non-digital asset data refers to data including the media data and additional information. Here, the additional information may include owner information of the non-digital asset. The owner information may indicate a plurality of owners. The additional information may further include various information about the non-digital asset. For example, when the non-digital asset is a cultural property, the non-digital asset data may further include information such as a production year, a writer, and a transaction price of the cultural property.

Hereinafter, some embodiments of the present disclosure will be described with reference to the drawings.

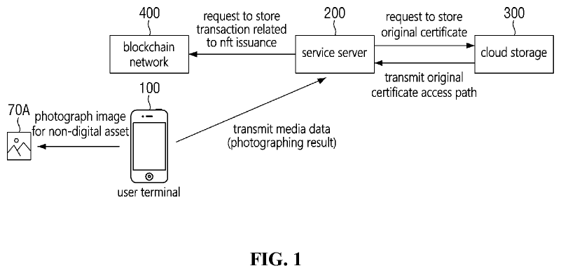

FIG. 1 is a block diagram of a system for generating an NFT for non-digital assets according to embodiments of the present disclosure.

Referring to FIG. 1, the NFT generation system according to the present embodiment may include a service server 200. The NFT generation system according to the present embodiment may further include a cloud storage 300 or a blockchain network 400.

The user terminal 100 may photograph the non-digital asset 70A using a built-in camera (not shown). The user terminal 100 may photograph the non-digital asset 70A a plurality of times, and may configure media data including images or videos obtained as a result of photographing. The user terminal 100 may transmit the media data to the service server 200.

In addition, the user terminal 100 may receive the additional information such as owner information of the non-digital asset 70A from the user and additionally transmit it to the service server 200.

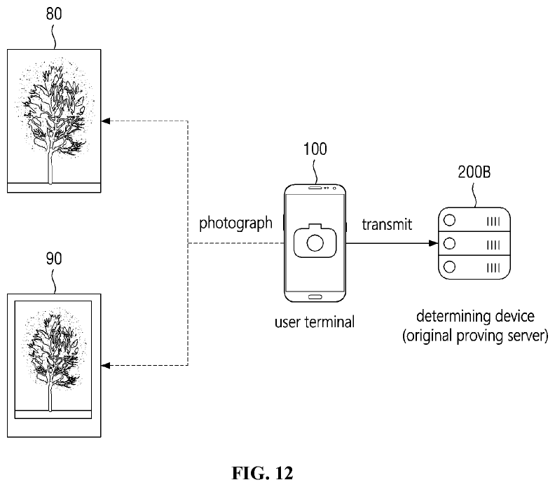

In some embodiments, the user terminal 100 may photograph the non-digital asset 70A by a photographing method designed to verify whether an image generated as a result of photographing is obtained by photographing a tangible subject. Since the photographing method will be described later in detail with reference to FIGS. 12 to 20, a description thereof will be omitted herein.

The service server 200 may receive the media data from the user terminal 100 and determine whether an image included in the media data is obtained by photographing a tangible subject. The service server 200 may perform a logic for determining whether the tangible subject is photographed in real time or periodically when the media data is received. Determination of whether or not a tangible subject is photographed will be described later in detail with reference to FIGS. 12 to 20.

The service server 200 may be implemented as a computing device including one or more processors, but is not limited thereto, and may be implemented in a distributed manner by one or more computing devices.

The service server 200 may further receive the additional information from the user terminal 100. The additional information may be composed of text. The service server 200 may convert the additional information into a specific standard format. For example, the standard format may be JSON Format.

Meanwhile, the conversion to the standard format may be performed in the user terminal 100. In this case, it may be understood that the service server 200 receives additional information converted into a standard format.

The service server 200 may automatically generate an original certificate for the non-digital asset by using the additional information converted into a standard format and the content. For example, the automatically generated original certificate may be configured in the form of a PDF file. Here, the information converted into the standard format may include analysis information of metadata of media data.

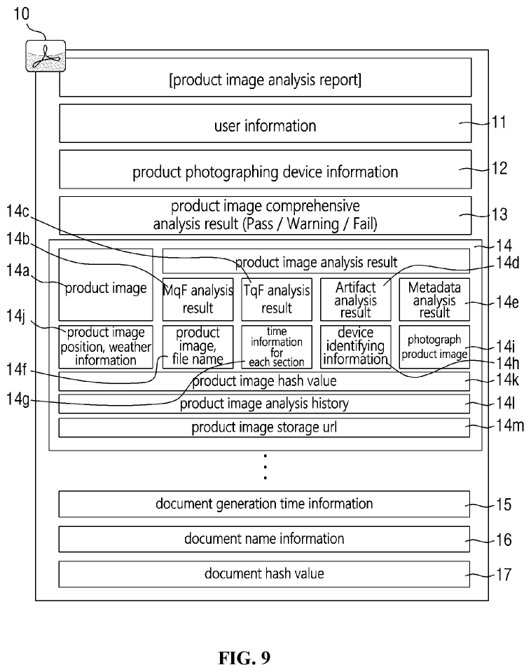

In addition, the service server 200 may extract the first hash data by using the content included in the media data, and extract the second hash data using the additional information converted into the standard format. The service server 200 may add hash data generated using the first hash data and the second hash data to the original certificate. The layout of the original certificate or information included therein will be described later in detail with reference to FIG. 9.

The automatically generated original certificate is a result of converting a non-digital asset into a digital asset. By generating an NFT for a non-digital asset using the original certificate, a transaction of an NFT for the non-digital asset can be made.

The service server 200 may aggregate the digital signature result using the secret key of the owner of the non-digital asset with respect to the original certificate, and generate a signed original certificate using the aggregation result.

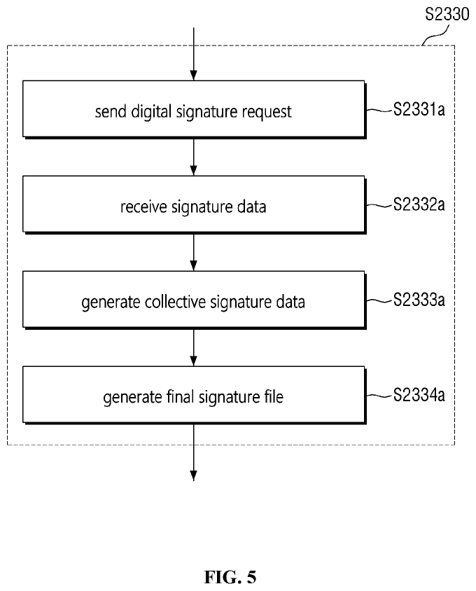

Meanwhile, the non-digital asset may have a plurality of owners. In this case, the service server 200 may aggregate the digital signature results of a plurality of owners through a method described later in detail with reference to FIGS. 5 and 21 to 31. The service server 200, through the aggregation of the digital signature results, can generate a signed original certificate without difficulty even when there are multiple owners of non-digital assets.

The service server 200 may verify the signed original certificate using a public key. The service server 200 may perform the verification in response to receiving a verification request from a terminal of a user who needs verification of the signed original certificate, such as a purchaser of the NFT.

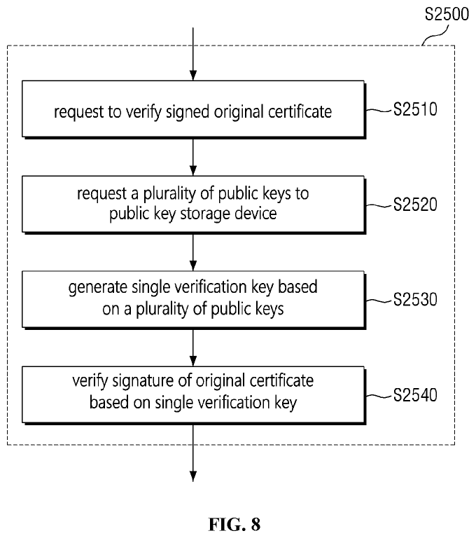

Meanwhile, the non-digital asset may have a plurality of owners. In this case, the service server 200 may verify the signed original certificate using the public key corresponding to the secret key of the plurality of owners through the method described later in detail with reference to FIGS. 8 and 21 to 31. By aggregating the public key corresponding to the secret key of each owner, even when there are multiple owners of non-digital assets, the signed original certificate can be verified without any difficulty.

The cloud storage 300 receives the file of the signed original certificate from the service server 200, stores the file of the original certificate, and provides an access path for accessing the original certificate to the service server 200.

The cloud storage 300 may be a device that provides a general-purpose cloud storage service such as InterPlanetary File System (IPFS) or AMAZON S3, or a device that provides a cloud storage service dedicated for a service described through the present disclosure.

The cloud storage 300 may generate a file name for the signed original certificate file by extracting hash data for the signed original certificate file, and combining the hash data with the generation date of the signed original certificate file. The cloud storage 300 may transmit an access path for accessing the signed original certificate stored in the storage system to the service server 200. When the service server 200 requests the cloud storage 300 for the original certificate file stored in the storage system, the cloud storage 300 allows the original certificate file stored in the storage system to be inquired. Here, the access path may mean a URL value.

In this case, the generating subject of the file name may be the service server 200. In this case, it may be understood that the service server 200 extracts the hash data for the original certificate file, and generates a file name for the signed original certificate file by combining the hash data with the generation date of the signed original certificate file.

The service server 200 may generate a blockchain transaction for issuing an NFT targeting the signed original certificate. The blockchain transaction may include hash data of the signed original certificate, an access path to the signed original certificate file, the number of NFT issuances, and information on the owner of each token. The service server 200 may send a request to the blockchain network 400 so that the blockchain transaction can be recorded in a distributed ledger that is distributed and stored through the blockchain network 400.

The blockchain network 400 is composed of a plurality of on-chain nodes, and is a network system, in which block information is serially recorded and updated by distributed agreement among the plurality of on-chain nodes. Block information recording and management of the blockchain network 400 is performed by a smart contract (not shown) embedded in the blockchain network 400. Since the specific configuration and function of the blockchain network 400 and the smart contract (or chaincode) are widely known in the art, a description thereof will be omitted here.

As described above, the NFT generation system for a non-digital asset according to the present embodiment can determine that the media data is an image obtained by photographing a tangible subject according to the original verification method according to the present disclosure with respect to the media data obtained by photographing the non-digital asset, aggregate information on non-digital assets that have been verified as original and convert them into digital assets. At this time, the converted non-digital asset is generated as an original certificate file.

Even when there are a plurality of owners of non-digital asset, it is possible to digitally sign the original certificate file by generating a single signature key. An NFT can be issued for the signed original certificate, and if there are a plurality of unspecified verification requests later, a single verification key can be generated to verify the non-digital assets.

According to the original verification method for non-digital assets according to the present disclosure, it is possible to secure the reliability of NFT transactions for non-digital assets. In addition, it is possible to provide the effect of converting non-digital assets into digital assets by aggregating various types of analysis information of non-digital assets and converting them into digital assets. In addition, even when there are a plurality of owners of digital assets, in the signing and verification of the original certificate for non-digital assets, a single signature key and a single verification key are generated to enable signing and verification, thereby yielding the effect of providing an NFT issuance and transaction method that enables convenient and reliable transactions based on NFT technology by ultimately tokenizing a non-digital asset into a plurality of tokens.

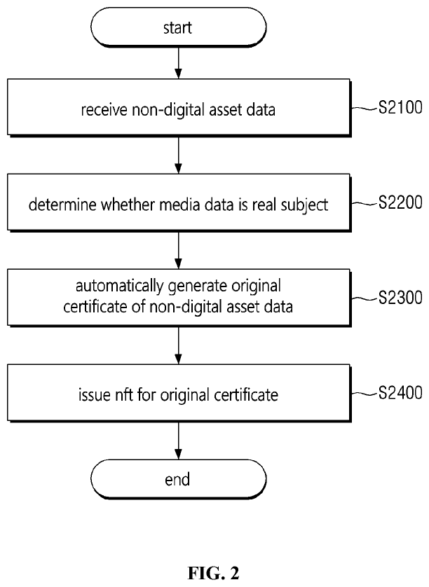

Next, an NFT issuance method for a non-digital asset according to another embodiment of the present disclosure will be described with reference to FIG. 2. The method for issuing NFTs for non-digital assets according to this embodiment may be performed by one or more computing devices. That is, in the NFT issuance method for non-digital assets according to the present embodiment, all operations may be performed by one computing device, and some operations may be performed by another computing device. Hereinafter, in describing the method according to the present embodiment, descriptions of subjects performing some operations may be omitted. In this case, it should be understood that the subject performing the corresponding operation is the computing device.

In operation S2100, the reception of non-digital asset data from the user terminal 100 to the service server 200 is made.

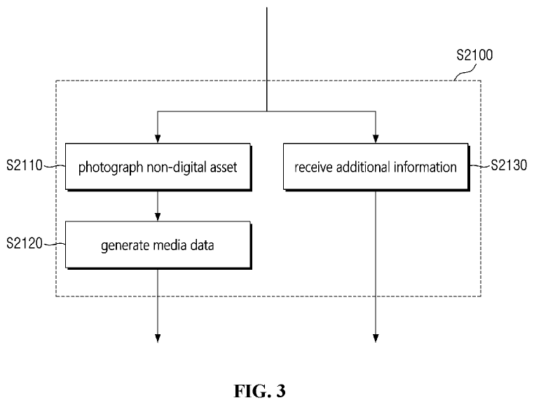

FIG. 3 is a flowchart illustrating an embodiment, in which operation S2100 of FIG. 2 is further detailed. Referring to FIG. 3, after photographing a non-digital asset (S2110), media data is generated based on the photographed image (S2120).

As an embodiment, when media data is generated by the user terminal 100, the user terminal 100 may generate the media data by a method of photographing a subject according to a photographing method based on a tangible subject discrimination algorithm. This is to determine whether the image contained in the media data is an image obtained by photographing a tangible subject or a processed image obtained by photographing an existing photographed image as a subject. Since the tangible subject algorithm proposed by the present disclosure and the image photographing method and reading method according thereto will be described in detail later with reference to FIGS. 12 to 20, a description thereof will be omitted herein.

In one embodiment, the non-digital asset owner information is received to the user terminal 100 or the service server 200 (S2130). When there are a plurality of owners of the non-digital asset, information about a plurality of owners is received.

Referring back to FIG. 2, in operation S2200, it is determined whether the media data is generated from an image obtained by photographing a tangible subject using a tangible subject discrimination algorithm. Hereinafter, with reference to FIGS. 12 to 20, a detailed description of the tangible subject discrimination algorithm referenced in the previous descriptions is provided. Hereinafter, the related description will be continued with reference to the drawings.

Image photographing method and determining method based on tangible subject discrimination algorithm

In this section, as a method for verifying whether the content contained in the data file is original, a tangible subject discrimination algorithm for determining whether an image of multimedia data is an image obtained by photographing a tangible subject or an image obtained by re-photographing an existing photographed image as a subject, an image photographing method based on the algorithm, and an image determining method are described.

FIG. 12 is a diagram for conceptually describing an image photographing method and determining method based on the tangible subject discrimination algorithm of the present disclosure.

The user terminal 100 (e.g., a photographing device) illustrated in FIG. 12 photographs the subjects 80 and 90 using a built-in camera. The subjects 80 and 90 to be photographed may be a tangible subject 80 that actually exists, or may be a picture or a video screen 90 taken previously. Hereinafter, a tangible subject, which is an object that actually exists, will be referred to as a 3-dimensional subject, and a subject, which is an image or video screen taken previously, will be referred to as a 2-dimensional subject.

At this time, in order to determine whether the photographed image is a 3-dimensional subject image or a 2-dimensional subject image, the user terminal 100 photographs a plurality of images with different focus points for the same subject. A plurality of images taken in this way will be referred to as a multi-focus image. Specific details of the multi-focus image and the photographing method thereof will be described later in detail, so a detailed description thereof will be omitted herein.

Then, after storing the multi-focus image, the user terminal 100 transmits the multi-focus image to the determining device 200B (e.g., a service server) at a synchronization point with the determining device 200B.

The determining device 200B analyzes the target image, that is, the previously transmitted multi-focus image, and determines its type on whether the corresponding image is a 2-dimensional subject image or a 3-dimensional subject image. For example, if the previously photographed subject is the 3-dimensional subject 80, an image, in which different portions are focused, will be photographed whenever the focus point is changed. For example, when the focus point is the background, an image with a clear background but a blurred tree will be photographed, and if the focus point is a tree, an image with a clear tree but a blurred background will be photographed. On the other hand, if the previously photographed subject is the 2-dimensional subject 90, an image with no significant difference in the focused portion will be photographed even when the focus point is changed. That is, in the case of the 2-dimensional subject 90, regardless of whether the focus point is a background or a tree, the distance (or depth) from the user terminal 100 is the same, so that both the background and the tree have the same sharpness (that is, similar to an existing taken image or video screen) will be photographed.

In this way, the determining device 200B analyzes the multi-focus image, and if the focused portions thereof are different from each other, the determining device 200B determines the image as a 3-dimensional subject image obtained by photographing the tangible subject 80. Conversely, the determining device 200B analyzes the multi-focus image, and if the focused portions thereof are identical to or similar to each other, the determining device 200B determines the image as a 2-dimensional subject image.

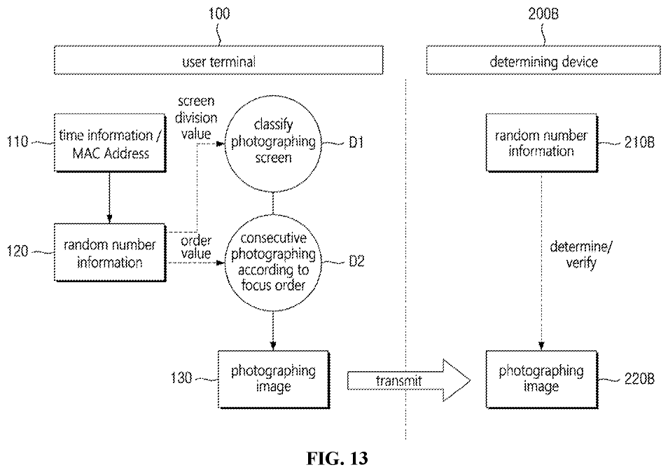

As an embodiment, in this case, the determining device 200B may determine the type of the multi-focus image by further referring to a focused region or a focused order of the focused portions. This will be described again below with reference to FIG. 13.

According to the method of the present disclosure, it is possible to easily determine whether a previously taken image or video screen is re-photographed and processed by manipulating, forgery or alteration as if a tangible subject is photographed, and submitted. If the focused portions of the multi-focus image are identical to or similar to each other, it can be seen that a 2-dimensional subject is photographed, and thus it can be known that an actual subject is not photographed.

FIG. 13 is a block diagram illustrating a detailed method of photographing a multi-focus image through the user terminal 100 and the determining device 200B shown in FIG. 12 and determining whether the image is a tangible subject image based thereon. In the embodiment of FIG. 13, a method of dividing a screen to classify a region to be multi-focused and photographing and determining a multi-focus image in consideration of a focus order for the classified region is described. Hereinafter, it will be described with reference to the drawings.

First, the user terminal 100 generates the random number information 120 according to a predetermined rule. As an embodiment, the random number information 120 may be generated based on time information and the MAC address 110 of the user terminal 100.

In order to share the random number information 120 with the determining device 200B, the user terminal 100 generates the random number information 120 using a predetermined random number generation algorithm. In this case, the random number generation algorithm may be an algorithm that receives time information when generating the random number 120 and a MAC address of the user terminal 100 as an input factor so that different random number information is generated according to a time for photographing a multi-focus image and a photographing device. There are various types of random number generation algorithms for generating random numbers based on a specific input factor, and their technical contents are also widely known in the art, so a detailed description thereof will be omitted here.

The generated random number information 120 may include a screen division value referenced for dividing and classifying a photographing screen when performing multi-focus photographing, and an order value designating a focus order of each divided and classified screen region.

The user terminal 100 classifies the photographing screen into a plurality of regions according to the screen division value among the random number information 120 (D 1). For example, if the screen division value is 3, the user terminal 100 classifies the photographing screen into three regions. Similarly, when the screen division value is 9, the user terminal 100 classifies the photographing screen into 9 regions. Thereafter, during multi-focus photographing, the user terminal 100 focuses on the subject based on the classified regions.

Next, the user terminal 100 selectively focuses the classified regions according to the order value among the random number information 120 to continuously photograph the subject (D2). For example, if it is assumed that there are three regions classified by the screen division value, and an order value is assigned to the classified regions as a vector value of [3, 2, 1], the same subject is repeatedly photographed continuously according to the order value in the way, in which, at first, the subject is photographed by focusing on the third region, to which the order value ‘1’ is assigned, among the classified regions, and then the same subject is repeatedly photographed by focusing on the second region, to which the order value ‘2’ is assigned, among the classified regions, and finally, the same subject is repeatedly photographed by focusing on the first region, to which the order value ‘3’ is assigned, among the classified regions.

In addition, the user terminal 100 stores a plurality of images generated through such multi-focus photographing as the multi-focus image 130. In the above example, the multi-focus image 130 will be composed of a total of three images since three consecutive photographing would have occurred by changing the focus point according to the order value [3, 2, 1].

Meanwhile, although it has been exemplified that multi-focus photographing is performed once for each classified region, the scope of the present disclosure is not limited thereto. For example, if there are 9 regions classified by the screen division value, and a vector value of [3, 0, 0, 2, 0, 0, 1, 0, 0] is assigned to the classified regions as the order value, only three consecutive photographing will occur sequentially focusing on the 7th region, the 4th region, and the 1st region. Multi-focus photographing is not performed in the 2nd, 3rd, 5th, 6th, 8th, and 9th regions, to which the order value ‘0’ is assigned. Accordingly, in this example, the photographing screen is divided and classified into nine regions, but only three images will be generated as the multi-focus image 130.

Thereafter, the user terminal 100 communicates with the determining device 200B, and transmits the stored multi-focus image 130 to the determining device 200B. In this case, the user terminal 100 transmits the previously obtained time information and MAC address 110 together to the determining device 200B for generating random number information in the determining device 200B.

As an embodiment, in this case, the user terminal 100 may pack each image according to the photographing order and transmit it to the determining device 200B so that the determining device 200B can identify the photographing order of each image included in the multi-focus image.

Or, as an embodiment, the user terminal 100 may transmit the multi-focus image together with information indicating the photographing order of each image to the determining device 200B so that the determining device 200B may identify the photographing order of each image included in the multi-focus image.

The determining device 200B receives the transmitted multi-focus image 220B, and identifies the time information and the MAC address 110 transmitted together with the multi-focus image 220B. Then, based on the identified time information and MAC address 110, random number information 210B for determining the multi-focus image 220B is generated. In this case, the determining device 200B may generate the random number information 210B by inputting the identified time information and the MAC address 110 as input factors to the same random number generation algorithm as that used by the user terminal 100 above. Since the same input factor is input to the same random number generation algorithm, the resultant random number information 210B will be also output that is the same value as the random number information 120 of the user terminal 100.

Then, the determining device 200B determines the type of the transmitted multi-focus image 220B with reference to the screen division value and the order value included in the random number information 210B.

Specifically, the determining device 200B refers to the screen division value among the random number information 210B and identifies whether the focused region of the multi-focus image matches the screen division value. If the screen division value and the focused region of the multi-focus image do not match each other (for example, if a region that is not classified according to the screen division value is in focus, or two or more of the regions classified according to the screen division value are in simultaneously focus), since multi-focus photographing is not performed according to a predetermined method, the determining device 200B may determine the type of the multi-focus image 220B as a 2-dimensional subject image or a forged or falsified image.

Also, the determining device 200B refers to the order value among the random number information 210B and identifies whether the focused order of the multi-focus image matches the order value. If the order value and the focused order of the multi-focus image do not match each other (for example, the order value allows the third region among the classified regions to be focused first, but in the actual multi-focus image, the first region is focused first), since multi-focus photographing is not performed according to a predetermined method, the determining device 200B may determine the type of the multi-focus image 220B as a 2-dimensional subject image, or a forged or falsified image.

On the other hand, if the focused region of the multi-focus image matches the screen division value and the order value of the random number information 210B, respectively, the determining device 200B may consider that the multi-focus photographing has been performed according to a predetermined method, and determine the type of the multi-focus image 220B as a 3-dimensional subject image or a tangible subject image.

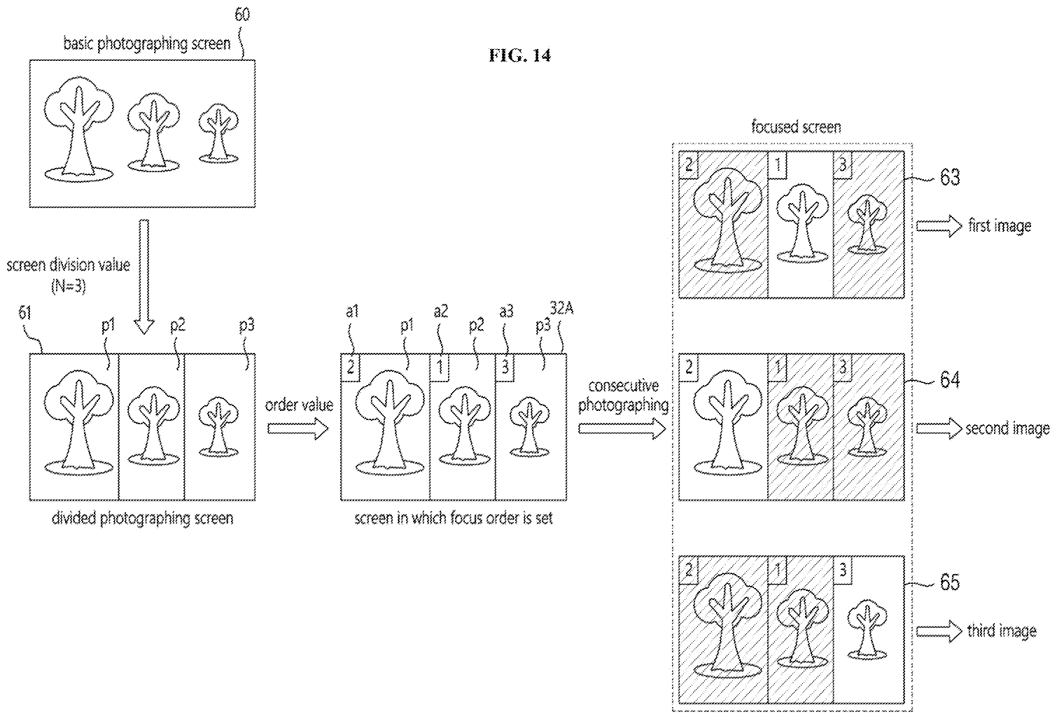

FIG. 14 is a diagram for describing in detail the multi-focus image mentioned in FIG. 13 and a photographing method thereof. In the embodiment of FIG. 14, multi-focus photographing when the screen division value is 3 and the order value is [2, 1, 3] will be exemplarily described.

Referring to FIG. 14, first, a basic photographing screen 60 is shown. This is, for example, a display screen of the user terminal 100, which indicates an initial photographing screen before starting multi-focus photographing. Three trees are displayed as subjects on the basic photographing screen 60.

Thereafter, the user terminal 100 obtains random number information and extracts a screen division value therefrom. The screen division value at this time is exemplified as 3 (N=3). In addition, the user terminal 100 classifies the basic photographing screen 60 into a plurality of regions according to the screen division value. In the middle portion of FIG. 14, a photographing screen 61, in which the entire screen is divided and classified into a plurality of regions p1, p2, and p3, is shown.

Then, the user terminal 100 sets a focus order for each of the classified regions p1, p2, and p3 according to the order value of the random number information. In the central portion of FIG. 14, a screen 62, in which a focus order a1, a2, a3 is set for each of the classified regions p1, p2, and p3, is shown. In the embodiment of FIG. 14, a case in that the focus order is set to ‘2’ for the first region p1, ‘1’ for the second region p2, and ‘3’ for the third region p3 among the classified regions is exemplified.

Then, the user terminal 100 performs consecutive photographing according to the set focus order a1, a2, a3 for each of the classified regions p1, p2, and p3. Specifically, the user terminal 100 first focuses the second region p2, in which the focus order is ‘1’, to photograph three trees as subjects. In FIG. 14, the non-focused region is indicated by hatching to distinguish it from the focused region. The result of performing the first multi-focus photographing in this way is generated as the first image 63. Then, the user terminal 100 focuses the first region p1, of which the focus order is ‘2,’ and repeatedly photographs three trees, which are the same subject. As before, the second multi-focus photographing result is generated as the second image 64. And, finally, the user terminal 100 focuses the third region p3, in which the focus order is ‘3,’ to repeatedly photograph three trees, which are the same subject. Likewise, the third multi-focus photographing result is generated as the third image 65.

The user terminal 100 packs and stores the generated images (first to third images) as multi-focus images when all multi-focus photographing according to the order value is completed.

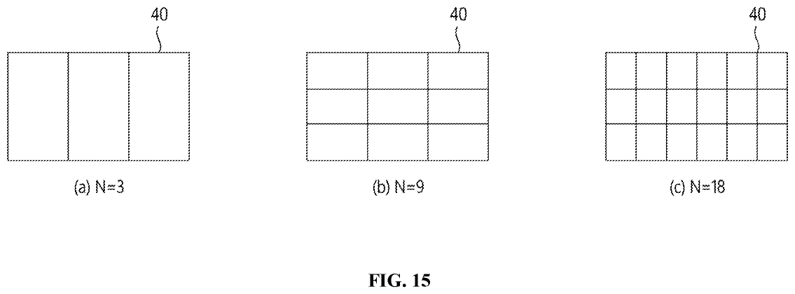

FIG. 15 is a view for describing examples of screen classification according to various screen division values by way of specific examples. Hereinafter, it will be described with reference to the drawings.

FIG. 15A is a case where the screen division value is 3 (N=3), and as in the example of FIG. 14, the entire photographing screen is classified into three regions. Here, a case, in which the entire screen is vertically divided, is illustrated, but the present invention is not limited thereto, and horizontal division is also possible.

FIG. 15B is a case where the screen division value is 9 (N=9), which is a case, in which the entire photographing screen is classified into 9 regions. As the most basic method, the entire screen may be equally divided into nine regions as shown, but the present invention is not limited thereto. For example, it is also possible to divide some regions into relatively larger areas.

FIG. 15C shows a case where the screen division value is 18 (N=18), and the entire photographing screen is classified into 18 regions. As in FIG. 14B, an example of equal division is illustrated, but the present invention is not limited thereto, and it is also possible to divide some regions into relatively larger areas or narrower areas.

Meanwhile, FIG. 15 exemplarily describes various cases of screen division, and it is obvious to those skilled in the art that various screen division methods not described herein (for example, when the screen division value is 3000, or when the screen division region is a triangle) can be modified and applied.

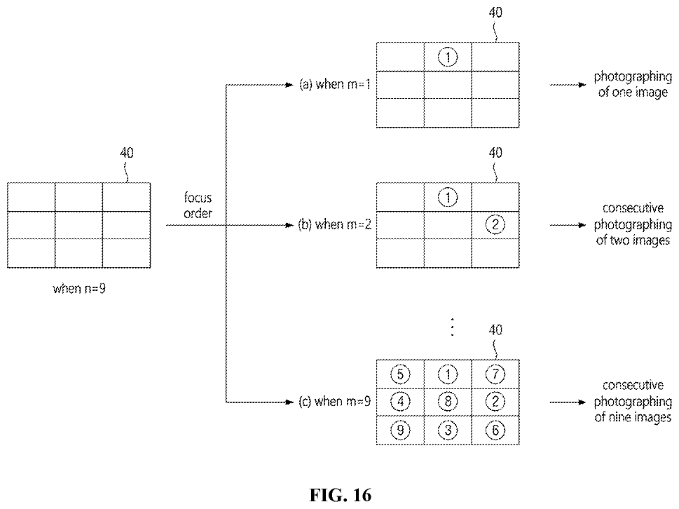

FIG. 16 is a view for describing examples of setting a photographing order according to various order values with specific examples. The embodiment of FIG. 16 exemplifies a case where the screen division value is 9 (N=9) for the sake of specificity of the description.

FIG. 16A illustrates a case, in which only one image is multi-focus photographed. Since it is to photograph a single image, it is somewhat far from the meaning of multi-focus, but for the sake of unity of terminology, in this case, the term multi-focus is also used. Since it is a case of photographing one image, an order value of ‘1’ is set for only one of the nine classified regions. Here, it is exemplified that the order value ‘1’ is set for the second region. When multi-focus photographing is started, the user terminal 100 identifies a region classified according to a screen division value, and focuses a second region among them to photograph one image. As an embodiment, in this case, the total order value extracted from the random number information 120 may be a vector value such as [0, 1, 0, 0, 0, 0, 0, 0, 0].

FIG. 16B shows a case where two images are multi-focus photographed. Since it is a case of photographing two images, order values of ‘1’ and ‘2’ are set for two regions of the nine classified regions. Here, it is exemplified that the order value ‘1’ is set for the second region and the order value ‘2’ is set for the sixth region. When multi-focus photographing is started, the user terminal 100 identifies the regions classified according to the screen division value, first focuses the second region to photograph one image, and then focuses the sixth region to photograph one image again. As an example, in this case, the total order value extracted from the random number information 120 may be a vector value such as [0, 1, 0, 0, 0, 2, 0, 0, 0].

FIG. 16C illustrates a case where 9 images are multi-focus photographed. Since it is a case of photographing 9 images, an order value of ‘1’ to ‘9’ is set for each of the 9 classified regions. When multi-focus photographing is started, the user terminal 100 identifies the region classified according to the screen division value, and sequentially focuses the 9 regions according to the order value shown in FIG. 16C to perform consecutive photographing. As an embodiment, in this case, the total order value extracted from the random number information 120 may be a vector value such as [5, 1, 7, 4, 8, 2, 9, 3, 6].

In this way, if the photographing screen is classified into a plurality of regions and a multi-focus photographing order is designated for them, security from external hacking or malicious forgery or falsification can be greatly improved.

For example, when the screen division value is 9 and three images are multi-focus photographed, the number of multi-focus images that can be generated therefrom becomes 9 to the third. Therefore, even if a multi-focus image is maliciously manipulated and submitted from the outside, the probability of matching the correct screen division value and order value (that is, the probability of determining it as a tangible subject image) is as low as 0.13%, it is possible to filter out forged and falsified images with a very high probability. Such security increases as the screen division value and the number of images to be taken increase. For example, if the screen division value is 18 and the number of images to be multi-focus photographed is 5, the probability of erroneously determining the manipulated image as a tangible subject image is extremely low to 1/1,889,569, which is obtained by dividing 1 by 18 to the 5th power.

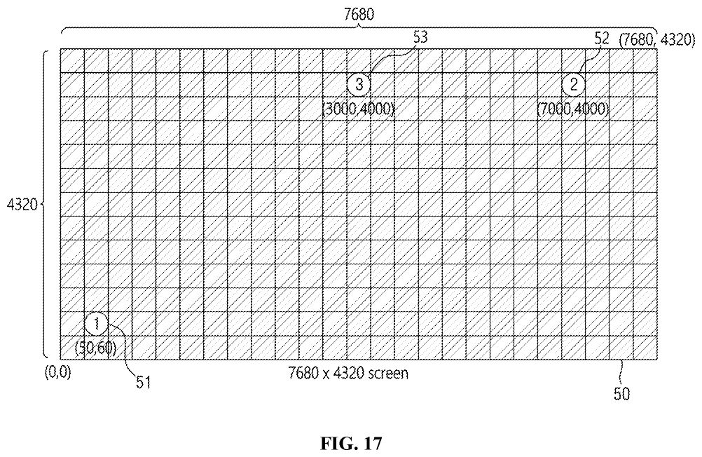

FIG. 17 is a view for describing an embodiment, in which the image photographing method according to the present disclosure is applied in units of pixels.

While the previous embodiments perform multi-focus photographing on regions separately classified according to screen division values, the embodiment of FIG. 17 performs multi-focus photographing on pixels of a photographing screen. Therefore, in the embodiment of FIG. 17, since the subject may be focused based on each pixel already determined in hardware, a screen division value for screen classification may not be required (since it can be seen that the photographing screen is already classified for each pixel)).

In FIG. 17, the user terminal 100 extracts an order value from the random number information 120, and sequentially focuses each pixel according to the extracted order value to perform multi-focus photographing of multiple images for the same subject.

For example, as in the illustrated example, it is assumed that the number of pixels of the photographing screen is 7680×4320, and the extracted order values are [0, 0, . . . , 3, . . . , 0, 0, . . . , 2, . . . , 0, 0, . . . , 1, . . . , 0, 0]. At this time, the order value ‘3’ matches the pixel at the coordinates (3000, 4000), the order value ‘2’ matches the pixel at the coordinates (7000, 4000), and the order value ‘1’ matches the pixel at the coordinates (50, 60), respectively.

The user terminal 100 photographs the first image by focusing on the pixel at the coordinates (50, 60) where the order value ‘1’ is set with reference to the extracted order value, and then, photographs the second image by focusing on the pixel at the coordinates (7000, 4000) where the order value ‘2’ is set, and finally photographs the third image by focusing on the pixel at the coordinates (3000, 4000) where the order value ‘3’ is set. The photographed images (first to third images) are packed as multi-focus images and transmitted to the determining device 200B.

The determining device 200B generates the random number information 210B in the same manner as in the previous embodiments, and extracts an order value therefrom. Then, the determining device 200B verifies the multi-focus image on whether each pixel is sequentially focused and photographed according to the extracted order value and determines whether the multi-focus image is a 3-dimensional subject image (tangible subject image), or a 2-dimensional subject image (forged, altered, or processed image) according to the result.

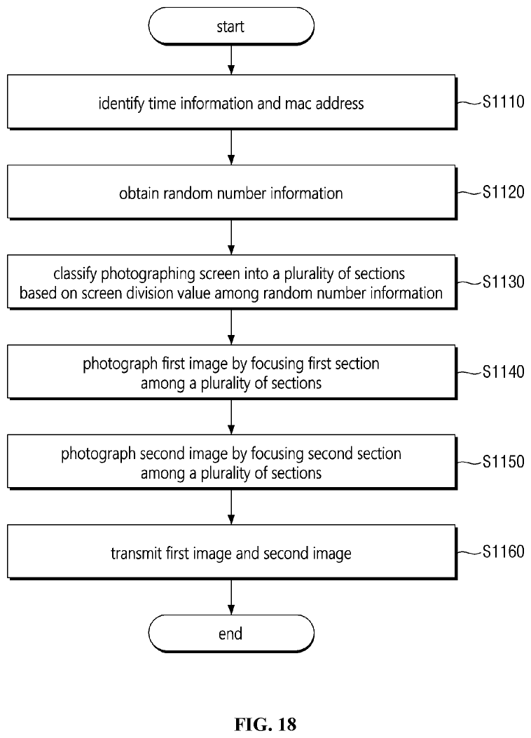

FIGS. 18-20 are flowcharts of various embodiments in accordance with the present disclosure. In order to avoid the complexity of the description, in the following description, ‘each region classified according to the screen division value’ will be briefly referred to as a ‘section.’ In addition, in order to avoid duplication of description, repeated description of the same content as described above will be omitted as much as possible.

FIG. 18 is a flowchart illustrating an image photographing method according to an embodiment of the present disclosure. The embodiment of FIG. 18 shows a method of photographing a multi-focus image performed by the user terminal 100 shown in FIG. 12. Accordingly, in the embodiment of FIG. 18, when the performing subject of each operation is omitted, it is assumed that the performing subject is the user terminal 100.

In operation S1110, the user terminal 100 identifies the time information and the MAC address. In this case, the time information may be time information of a clock built into the user terminal 100 or time information obtained through a network connected to the user terminal 100. The MAC address may be the MAC address of the user terminal 100.

In operation S1120, the user terminal 100 obtains random number information based on the identified time information and MAC address. As an embodiment, the user terminal 100 may obtain the random number information by inputting the time information and the MAC address as input information to a predetermined random number generation algorithm.

In this case, the obtained random number information may include a screen division value and an order value for multi-focus photographing.

In operation S1130, the user terminal 100 classifies the photographing screen illuminating the subject into a plurality of sections based on the screen division value among the random number information.

Thereafter, the user terminal 100 sets the focus order of the plurality of sections previously classified based on the order value among the random number information, and focuses each section according to the set focus order to perform consecutive photographing.

In operation S1140, the user terminal 100 photographs a first image by focusing on a first section having an earlier focus order among the plurality of sections.

In operation S1150, the user terminal 100 photographs a second image by focusing on a second section having a later focus order among the plurality of sections.

In operation S1160, the user terminal 100 packs and stores the photographed first image and the second image as a multi-focus image. In this case, the time information and the MAC address referenced for obtaining the random number information may be packed together. Then, when the user terminal 100 is connected to the determining device 200A through a network, the user terminal 100 transmits the previously stored multi-focus image to the determining device 200B.

Thereafter, the determining device 200B verifies whether each section is focused according to the screen division value and the order value with respect to the transmitted multi-focus image, and determines the type thereof.

Meanwhile, in the embodiment of FIG. 18, a case of multi-focus photographing of a plurality of sections has been described, but the scope of the present disclosure is not limited thereto. For example, it is also possible to generate only one image (first image) as a multi-focus image by focusing on only one section (first section) among the plurality of sections. In this case, the determining device 200B determines the type of multi-focus image by only identifying whether the focused section of the first image is a photographing section specified in the order value.

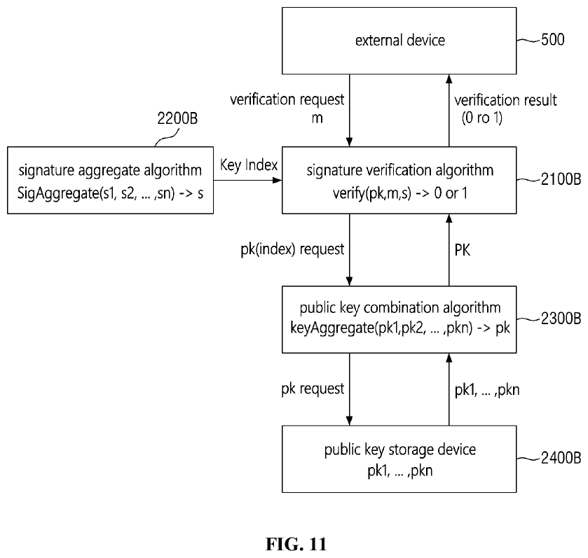

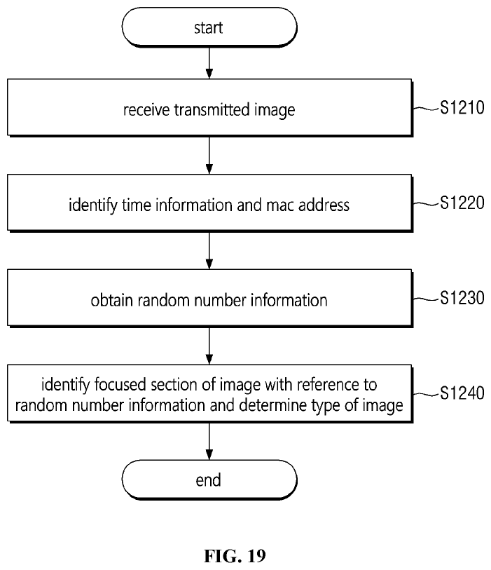

FIG. 19 is a flowchart illustrating an image determining method according to an embodiment of the present disclosure. The embodiment of FIG. 19 shows a method of determining a multi-focus image performed by the determining device 200B shown in FIG. 11. Therefore, in the case where the performing subject of each operation is omitted in the embodiment of FIG. 19, it is assumed that the performing subject is the determining device 200B.

In operation S1210, the determining device 200B receives the multi-focus image transmitted by the user terminal 100.

In operation S1220, the determining device 200B identifies the time information and the MAC address transmitted together from the user terminal 100.

In operation S1230, the determining device 200B obtains random number information based on the previously identified time information and MAC address. As an embodiment, the determining device 200B may obtain random number information by inputting the identified time information and MAC address as input information to the same random number generation algorithm as that of the user terminal 100. The obtained random number information may include a screen division value and an order value used for multi-focus photographing.

In operation S1240, the determining device 200B refers to the screen division value and the order value of the random number information, and verifies whether the focused sections of the multi-focus image match the screen division value and the order value, and determines the type of multi-focus image as a 3-dimensional subject image (tangible subject image) or a 2-dimensional subject image (forged, altered, or processed image) according to the verification result.

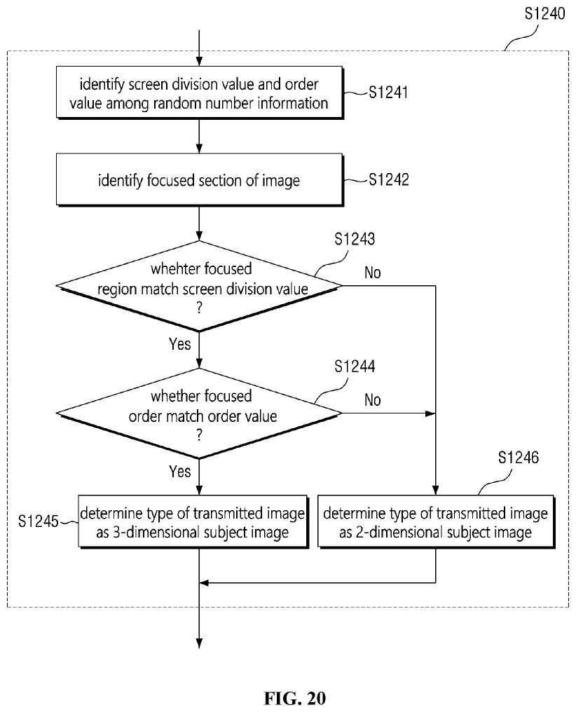

This will be described in more detail with reference to FIG. 20. FIG. 20 is a flowchart illustrating an embodiment, in which the operation of determining the type of the image of FIG. 19 (S1240) is further detailed. Hereinafter, it will be described with reference to the drawings.

In operation S1241, the determining device 200B identifies a screen division value and an order value among the random number information.

In operation S1242, the determining device 200B identifies a focused section of each image included in the multi-focus image. For example, when the first to third images are included in the multi-focus image, the determining device 200B identifies the focused section of the first image, the focused section of the second image, and the focused section of the third image, respectively.

In operation S1243, the determining device 200B identifies whether the focused region of each image matches the screen division value. If the focused region of each image does not match the screen division value (for example, when two or more of the sections according to the screen division value are simultaneously focused within one image, etc.), the present embodiment proceeds to operation S1246. Conversely, when the focused region of each image matches the screen division value (e.g., the focused region of each image fits in the section according to the screen division value), the present embodiment proceeds to operation S1244.

In operation S1244, the determining device 200B identifies whether the focused order of each section matches the order value. If the focused order of each section does not match the order value (e.g., the order value of the first section is ‘3,’ but in fact, the first section is focused and photographed first, etc.), the present embodiment proceeds to operation S1246. Conversely, when the focused order of each section matches the order value (e.g., when it is sequentially focused and photographed according to the order value set for each section), the present embodiment proceeds to operation S1245.

In operation S1245, since it is identified that the transmitted multi-focus image has been multi-focus photographed according to the screen division value and the order value, the determining device 200B determines the type of the multi-focus image as a 3-dimensional subject image (or tangible subject image).

On the other hand, in the case of proceeding from operations S1243 and S1244 to operation S1246, since the transmitted multi-focus image is not multi-focus photographed according to the screen division value and the order value, the determining device 200B determines the type of the multi-focus image as a 2-dimensional subject image (or forged, altered, or processed image).

Referring again to FIG. 2, operation S2300 will be described. In operation S2300, when it is determined that the media data is generated based on an image obtained by photographing a tangible subject, an original certificate of non-digital asset data is automatically generated.

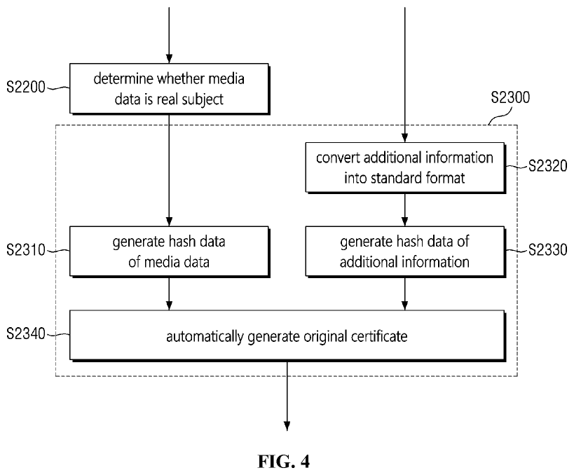

FIG. 4 is a flowchart illustrating operation S2300 of FIG. 2. Referring to FIG. 4, the received additional information may be converted into a standardized format (S2320). Here, the standardized format may be JSON format. Here, the information converted into a standardized format may include analysis information of non-digital assets. For example, information of non-digital assets may be converted into a standardized format through 2D/3D analysis and various metadata analysis. As information related to non-digital assets and owner information are converted into a standardized format, conversion into digital assets is facilitated.

The additional information and information on the media data determined to photograph a tangible subject in operation S2200 may be aggregated, and hash data may be extracted using the aggregated information and a hash function of the information (S2310 and S2330). As a result, an original certificate is automatically generated using the extracted hash data (S2340). Here, the aggregated information may include 2D/3D analysis information, information through various meta data analysis, or information related to other media data.

This will be further described with reference to FIG. 9.

FIG. 9 is a diagram for describing an exemplary layout 10 of an original certificate when the format of the original certificate file is PDF. The original certificate includes owner information (user information) 11, photographing device information 12 and/or image comprehensive analysis result 13, etc., and other document generation time information 15, document name information 16 and document hash data 17 may be included.

In addition, the content of the original certificate may include an image analysis result report 14 for an image photographed based on a tangible subject discrimination algorithm. Here, when there are N images taken based on the algorithm, N analysis results are also generated and included in the contents of the original certificate.

The image analysis result report 14 may include image analysis results 14b to 14i, product image 14a, image position and weather information 14j, product image hash data 14k, product image analysis history 141 and/or product image storage access path 14m, etc.

The image analysis result may include the analysis result 14b of the image photographing and determining method (MpF analysis method) based on the tangible subject discrimination algorithm of the present disclosure, the ToF analysis result 14c, the Artifact analysis result 14d, and the metadata analysis result 14e, product image description 14i, device hacking information 14h, time information for each section 14g and/or image file name 14f Here, the ‘section’ in the time information for each section 14g may mean ‘each region classified according to the screen division value’ according to the image photographing and determining method based on the tangible subject discrimination algorithm of the present disclosure.

To convert non-digital assets into digital assets by generating the original certificate file 10 based on the information of non-digital assets such as image analysis results for non-digital assets, an effect of easily determining the facts about non-digital assets can be yielded.

FIG. 5 illustrates a method of generating a signed original certificate by generating collective signature data according to an embodiment of operation S2330 of FIG. 4.

Referring to FIG. 5, an electronic signature request may be transmitted from the service server 200 to the terminal of the owner of the non-digital asset when the original certificate is generated (S2331a). In this case, when there are a plurality of owners of non-digital assets, a digital signature request may be transmitted to each owner.

Signature data is received from the owner of the non-digital asset to the service server 200 (S2332a). When there are a plurality of owners of the non-digital asset, a plurality of signature data is received, and collective signature data is generated from the plurality of signature data (S2333a). As a result, a signed original certificate file is generated using the collective signature data (S2334a).

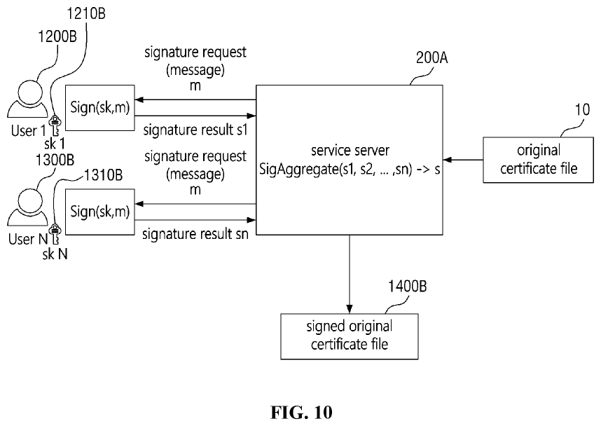

This will be further described with reference to FIG. 10.

FIG. 10 is a diagram illustrating the contents of generating a signed original certificate file by generating a single collective signature data from a plurality of signature data when there are a plurality of owners of non-digital assets.

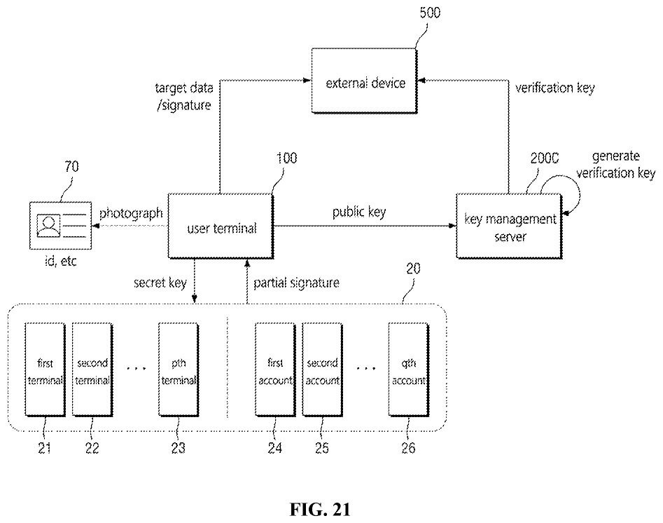

Referring to FIG. 10, in response to a signature request from the service server 200, data for signing by each owner of a non-digital asset is received from the service server (multi sign aggregate device) 200A to each owner. Taking the first owner 1200B as an example, the first owner 1200B signs the received signature request message through a signature generation algorithm using the secret key 1210B of the first owner 1200B, and as a result, the signature result s1 is transmitted to the service server 200A. The service server 200A that has received the result value sn for the signature generation algorithm up to the Nth owner 1300B may generate a single signature key through the signature aggregate algorithm. Based on the generated single signature key, the original certificate 10 is signed to generate a signed original certificate 1400B. By the signature method of generating a single signature key by the signature aggregate algorithm, it is possible to provide an effect of proving and verifying the original even for non-digital assets owned by a plurality of owners. The algorithms will be described later in detail with reference to FIGS. 21 to 31.

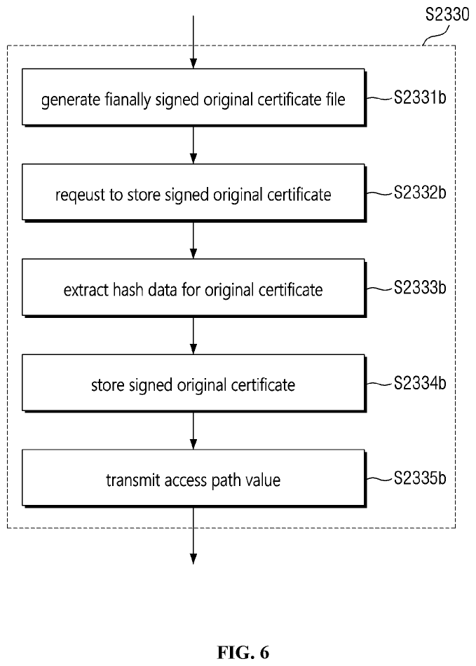

FIG. 6 illustrates a method of storing a digitally signed original certificate in a storage system of a cloud storage according to an embodiment of operation S2330 of FIG. 4.

Referring to FIG. 6, after receiving the digital signature data for the original certificate from the terminal of the non-digital asset owner and generating an original certificate signed based on a single signature key (S2331b), together with the storage request (S2332b) to the storage system of the cloud storage 300 for the generated signed original certificate, the service server 200 may extract hash data for the original certificate (S2333b) so that the hash data is combined with the information of the signed original certificate to generate a file and store it in the storage system (S2334b). Here, the information on the signed original certificate may include a generation date of the original certificate. In addition, the service server 200 may receive an access path to the signed original certificate from the storage system of the cloud storage 300. Here, the access path may be a URL value that can access the original certificate.

Referring again to FIG. 2, operation S2400 will be described. In operation S2400, as described above in the description of FIG. 1, the service server 200 may generate a transaction by making a request to store a blockchain transaction for issuing the NFT using the hash data of the original certificate and the access path transmitted from the cloud storage 300 to the blockchain network 400. Accordingly, an NFT can be finally issued for the original certificate of non-digital assets.

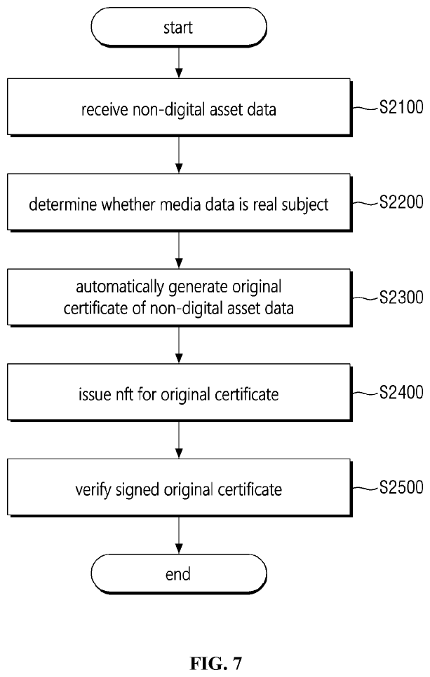

FIG. 7 is a flowchart illustrating a method of verifying a signed original certificate according to another embodiment of the present disclosure. FIG. 7 illustrates an embodiment of verifying the signed original certificate of the issued NFT after issuance of the NFT. Operations S2100 to S2400 among the operations of FIG. 7 are the same as operations S2100 to S2400 of FIG. 2. Accordingly, in the present embodiment, the description of operations S2100 to S2400 is omitted in order to avoid duplication of description.

In operation S2500, the signed original certificate may be verified according to a plurality of unspecified requests. According to the verification procedure, by verifying the owner of the non-digital asset for which the NFT is issued, the effect of increasing the reliability of the NFT transaction is provided.

FIG. 8 is a flowchart detailing a method of verifying a signed original certificate when there are a plurality of owners of non-digital assets according to an embodiment of operation S2500 of FIG. 7.

When there is a verification request for the signed original certificate (S2510), a public key corresponding to the secret key of the owner of the signed original certificate may be requested to the public key storage device 2400B. The public key storage device 2400B may be the service server 200 or the user terminal 100. The subject of the verification request may be, for example, the external device 500. In one embodiment, the external device 500 may be multiple unspecified terminal devices or a server of an external institution.

As an embodiment, when there are a plurality of owners of non-digital assets, a plurality of public keys may be requested to the service server 200 (S2520). In this case, the service server 200 may generate a single verification key based on the plurality of public keys (S2530). The signature of the original certificate is verified based on the single verification key (S2540), and the verification result is transmitted to the subject of the verification request.

This will be further described with reference to FIG. 11.

FIG. 11 is a diagram illustrating the contents of verifying a signed original certificate by generating a single public key for verification from a plurality of public keys when there are a plurality of owners of non-digital asset.

Referring to FIG. 11, when there is a verification request for the signed original certificate from the external device 500 to the service server 200, the service server 200 may request each public key to the public key storage device 2400B for a plurality of owners of non-digital assets. For each public key, a public key (PK) for integrated verification may be generated based on key index information for the secret key of each owner by the verification key aggregate algorithm 2300B. Thereafter, the service server 200 may verify the original certificate by using the signature verification algorithm 2100B based on the result value of the signature aggregate algorithm 2200B, the public key for integrated verification, and the verification request data. By the verification method of generating a single verification key by the verification key aggregate algorithm, it is possible to provide the effect of verifying and identifying the original even for non-digital assets owned by a plurality of owners. The algorithms will be described later in detail with reference to FIGS. 21 to 31.

Hereinafter, with reference to FIGS. 21 to 31, detailed descriptions of the signature aggregate algorithm, the verification algorithm, and the verification key aggregate algorithm referenced in the previous descriptions are provided. Hereinafter, the related description will be continued with reference to the drawings.

Original proof method based on signature aggregate algorithm and verification key aggregate algorithm

In this section, as a method for verifying whether the content contained in a data file is original, an original proof method for verifying whether media data is original data or processed data, and a user terminal and a key management server for this will be described.

FIG. 21 is a schematic diagram for describing an original proof method according to embodiments of the present disclosure. Referring to FIG. 21, the original proof method may be performed between the user terminal 100, a key management server (e.g., a service server) 200C, or an external device 500.

The user terminal 100 may generate a plurality of secret and public key pairs to be used in the original proof method. For example, the user terminal 100 generates a first encryption key pair, for example, a first secret key and a first public key using a key generation algorithm, and uses the key generation algorithm again to generate a second secret key and a second public key, and repeats this to generate an arbitrary number of a plurality of secret keys and public keys.

The user terminal 100 distributes and stores a plurality of generated secret keys in a plurality of key storage means 20. A plurality of key storage means 20 may comprise a plurality of terminals 21, 22, 23 capable of communicating with the user terminal 100 directly or via the key management server 200C, or a plurality of user accounts 24, 25, 26. The user terminal 100 distributes and stores each secret key in a plurality of terminals 21, 22, 23 or a plurality of accounts 24, 25, 26 so that the plurality of generated secret keys are not concentrated in any one place. Here, storing the secret key in the user's accounts 24, 25, 26 may mean storing the secret key in an external service server accessible through the user's accounts 24, 25, 26. For example, if the first account 24 is the user's KakaoTalk account, storing the secret key in the first account 24 may mean storing the secret key in the KakaoTalk service server accessible through the user's KakaoTalk account. Each of the devices 21, 22, 23, 24, 25, and 26 included in the plurality of key storage means 20 may be physically separated from each other.

As an embodiment, the user terminal 100 may store any one of the plurality of generated secret keys in the user terminal 100 and distribute and store the remaining secret keys in the plurality of key storage means 20.

Meanwhile, the plurality of public keys generated together with the secret key are transmitted to the key management server 200C. The key management server 200C stores the transmitted plurality of public keys in its own storage.

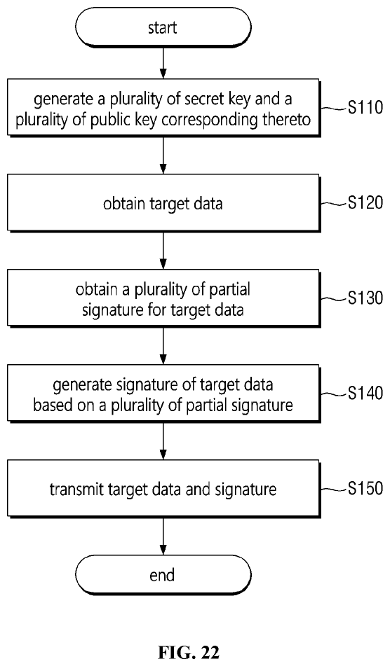

The user terminal 100 generates target data to be provided to the external device 500. The target data may be multimedia data including an image obtained by photographing the subject 70. After generating the target data, the user terminal 100 generates a signature for proving the original of the target data. In this case, the user terminal 100 may receive a plurality of partial signatures associated with the target data from the plurality of key storage means 20, and generate a signature of the target data based on a combination of the plurality of partial signatures. The user terminal 100 transmits the generated target data and the signature of the target data to an external device. A specific method of generating the target data and the signature of the target data will be described in more detail below with reference to FIG. 22.

The external device 500 receives target data and a signature from the user terminal 100. Then, to verify the original of the target data, a verification key is requested to the key management server 200C. As an embodiment, the external device 500 may be a server of an external institution, such as a government office or an insurance company, to which a user should submit target data as proof material.

The key management server 200C generates a verification key in response to the request of the external device 500 and provides the generated verification key to the external device. In this case, the key management server 200C may extract public keys necessary for generating the verification key from among the plurality of public keys previously received from the user terminal 100, and generate a verification key based on the combination of the extracted public keys.

As an embodiment, the key management server 200C may generate a verification key to correspond to the signature provided by the user terminal 100 to the external device 500. For example, if the signature is generated based on the first secret key and the second secret key among the distributed and stored secret keys, the key management server 200C may extract the first public key and the second public key from among the plurality of public keys, and generate a verification key based on the extracted first public key and the second public key. As another example, if the signature is generated based on the first secret key, the third secret key, and the fourth secret key among the distributed and stored secret keys, the key management server 200C may extract the first public key, the third public key and the fourth public key among a plurality of public keys, and generate a verification key based on the extracted first public key, the third public key, and the fourth public key. Here, it assumed that the first secret key and the first public key, the second secret key and the second public key, the third secret key and the third public key, and the fourth secret key and the fourth public key are encryption key pairs corresponding to each other, respectively.

When the key management server 200C provides the verification key to the external device 500, the external device 600A verifies the validity of the signature transmitted by the user terminal 100 using the provided verification key. For example, the external device 500 may input a signature, a verification key, and target data as input parameters to the verification algorithm as shown in Equation 1 below, and verify the validity of the signature through a result value calculated therefrom.

Verify(pk,m,s)→Result: 0 or 1 [Equation 1]

Here, Verify( ) is a verification algorithm or verification function, pk is a verification key, m is target data, and s is a signature. In this case, hash data of the target data may be input to the verification algorithm instead of the target data.

If the result value according to Equation 1 is 1, it may be determined that the signature is valid and the original proof of the target data has been successful. On the other hand, if the result of Equation 1 is 0, it may be determined that the signature is not valid and the original proof of the target data has also failed. However, this is exemplary and the scope of the present disclosure is not limited thereto. For example, complementary to the previous example, when the result value according to Equation 1 is 0, it may be determined that the signature is valid, and when the result value according to Equation 1 is 1, it may be determined that the signature is invalid.

According to the embodiment of FIG. 1 described above, a plurality of secret keys for verifying a digital signature are distributed and stored in the user terminal 100 and the plurality of key storage means 20. Accordingly, even if the secret key stored in one device is leaked to the outside, the secret keys stored in the other devices are safely stored, and since it is impossible to forge a signature with only one leaked secret key, the security of the secret key can be maintained as a whole.

FIG. 22 is a flowchart illustrating an original proof method according to an embodiment of the present disclosure. In FIG. 22, the original proof method described in FIG. 21 will be described in more detail from the viewpoint of the user terminal 100. Therefore, when the performing subject is omitted in each operation of FIG. 22, it is assumed that the performing subject is the user terminal 100 of FIG. 21. Meanwhile, in the description of FIG. 21, the content overlapping with the previously described content is omitted for the sake of brevity of the description.

In operation S110, a plurality of secret keys and a plurality of public keys corresponding thereto are generated. In this case, each secret key and a corresponding public key pair may be generated using a key generation algorithm as shown in Equation (2).

KeyGen(a)→Result value: ski,pki [Equation 2]

Here, KeyGen( ) is a key generation algorithm that generates an encryption key pair, a is a random number or an arbitrary value input as an input parameter to the key generation algorithm, ski is the ith secret key, and pki is the ith public key, and ski and pki are encryption key pairs corresponding to each other.

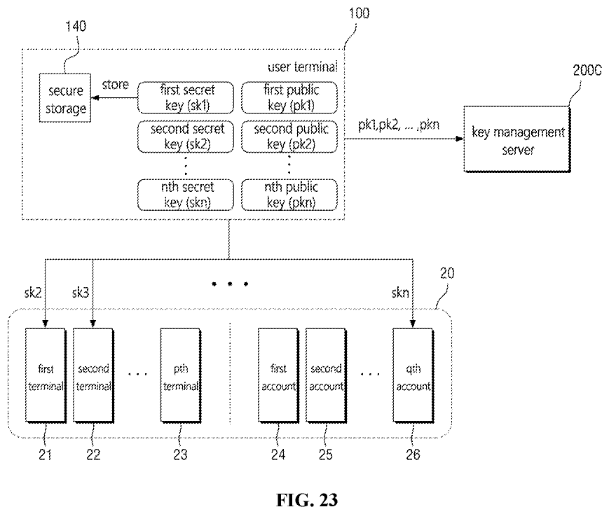

If the key generation algorithm is repeatedly performed, a plurality of secret key and public key pairs may be generated as many as desired. The plurality of generated secret keys are distributed and stored in the user terminal and the plurality of key storage means, and the plurality of generated public keys are stored in the key management server. For a further description, refer to FIG. 23.

In FIG. 23, the user terminal 100 generates a plurality of encryption key pairs through a key generation algorithm as in Equation 2 above. For example, the first secret key (sk1) and the first public key (pk1) may be generated by performing the key generation algorithm first, and the second secret key (sk2) and the second public key (sk2) may be generated by performing the key generation algorithm second, and an nth secret key skn and an nth public key pkn may be generated by similarly performing the key generation algorithm nth.

The first secret key sk1 among the plurality of generated secret keys is stored in the secure storage 140 of the user terminal 100. The remaining secret keys (sk2, sk3, skn) among the plurality of generated secret keys are distributed and stored in the plurality of key storage means 20. Specifically, the second secret key sk2 may be stored in the first terminal 21, the second secret key sk3 may be stored in the second terminal 22, and the remaining secret keys may be sequentially stored in the other terminal 23 or accounts 24 and 25, and then the nth secret key skn may be stored in the qth account 26. However, this is an illustration of a specific case for convenience of description, and the scope of the present disclosure is not limited thereto. For example, the remaining secret keys sk2, sk3, skn may be distributed and stored only in the terminals 21, 22, and 23 among the plurality of key storage means 20, or the remaining secret keys sk2, sk3, . . . , skn may be distributed and stored only in the accounts 24, 25, 26 among the plurality of key storage means 20.

Meanwhile, the generated plurality of public keys pk1, pk2, . . . , pkn are transmitted to the key management server 200C and stored in the key management server 200C.

Returning to FIG. 22, in operation S120, target data is obtained. Here, the target data is data for which the original is to be proof to the external device 500, and may be multimedia data including documents, images, moving pictures, or audio.

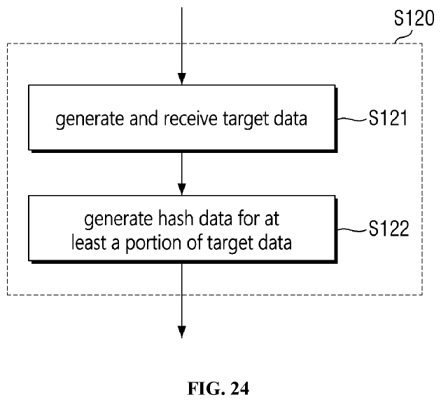

As an embodiment, after the target data is obtained, hash data for at least a portion of the target data may be further generated. When the target data is directly input to the signature generation algorithm, the message length of the target data input as an input parameter to the signature generation algorithm may vary for each target data. On the other hand, if the hash data is input to the signature generation algorithm after obtaining the hash data of the target data, the corresponding hash data has a fixed length, so that it is possible to provide an input parameter of a certain length to the signature generation algorithm. For a further description, refer to FIG. 24.

FIG. 24 is a flowchart illustrating operation S120 of FIG. 22.

In operation S121, the target data is generated or received. For example, the target data may be directly generated in the user terminal by a method of photographing a subject using a camera of the user terminal. Alternatively, the target data may be received by the user terminal by being externally generated and then transmitted to the user terminal through a wired or wireless network.

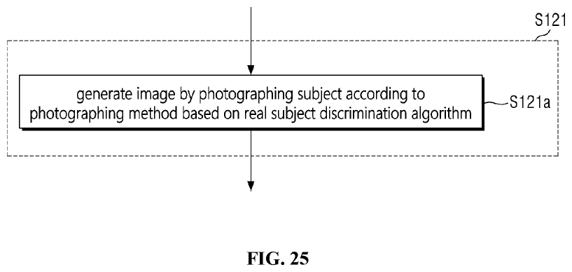

As an embodiment, when the target data is generated in the user terminal, as in the embodiment of FIG. 25, the user terminal may generate the target data by a method of photographing a subject by a photographing method based on a tangible subject discrimination algorithm.

In operation S122, hash data for at least a portion of the target data is generated. For example, hash data of the target data may be generated by inputting all of the target data into the hash function or inputting only meta data of the target data into the hash function. The generated hash data may have a fixed length regardless of the size of the input target data.

Returning again to FIG. 22, in operation S130, a plurality of partial signatures associated with the target data are obtained. In this case, each of the plurality of partial signatures may be a value obtained by inputting one of the plurality of secret keys and the target data to the signature generation algorithm. Alternatively, each of the plurality of partial signatures may be a value obtained by inputting one of a plurality of secret keys and hash data of the target data to the signature generation algorithm. In this case, the hash data is data of a fixed size obtained by inputting at least a portion of the target data into the hash function as described above.

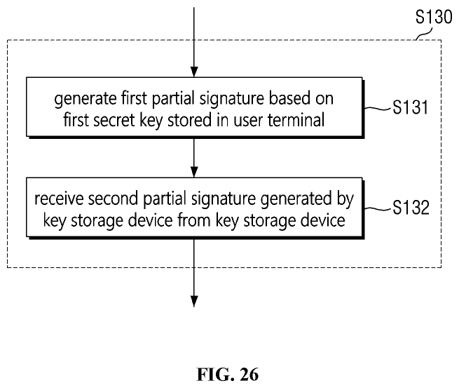

As an embodiment, the plurality of partial signatures may be respectively generated based on different secret keys among the plurality of secret keys. This will be further described with reference to FIG. 26.

FIG. 26 is a flowchart illustrating operation S130 of FIG. 22. In this embodiment as in the previous embodiments, it is assumed that the plurality of secret keys generated by the user terminal are distributed and stored in the user terminal and the plurality of key storage means.

In operation S131, a first partial signature associated with the target data is generated based on the first secret key stored in the user terminal. In this case, the first partial signature may be generated using a signature generation algorithm as shown in Equation 3.

Sign(ski,m)→result: si [Equation 3]

Here, Sign( ) is a signature generation algorithm for generating a partial signature using a secret key, ski is the ith secret key, m is the target data, and si is the ith partial signature associated with the target data. In this case, the hash data of the target data may be input to the signature generation algorithm instead of the target data.

Partial signatures are generated for other secret keys in a similar manner. Specifically, in the first terminal, in which the second secret key is stored, a second partial signature is generated by using the second secret key as an input parameter of the signature generation algorithm, and in the second terminal, in which the third secret key is stored, a third partial signature is generated by using the third secret key as an input parameter of the signature generation algorithm. In this way, partial signatures corresponding to each of the secret keys are generated in the terminal or accounts, in which the secret keys are stored. In this case, the meaning that the partial signature is generated in the account may mean that the partial signature is generated in an external service server accessible through the account.

In operation S132, the partial signatures generated by the key storage means are transmitted to the user terminal. Since the first partial signature is possessed by the user terminal, the user terminal receives the remaining partial signatures from the key storage means except for this. Specifically, a second partial signature is received from the first terminal among the key storage means, and a third partial signature is received from the second terminal among the key storage means, and in this way, each partial signature is received from the terminal or accounts of the key storage means. In this case, the reception of the partial signature from the account may mean that the partial signature is received from an external service server accessible through the account.

Through the above process, each partial signature (s1, s2, sn) corresponding to each generated secret key (sk1, sk2, skn) is collected in the user terminal.

Returning to FIG. 21, in operation S140, a signature of the target data is generated based on the plurality of obtained partial signatures. In this case, the signature may be generated using a signature aggregate algorithm as shown in Equation 4.

SigAggregate(s1,s2, . . . ,sn)→result: s [Equation 4]

Here, SigAggregate( ) is an algorithm for generating a single signature based on a plurality of partial signatures, si is the ith partial signature, and s is a signature obtained as a result value.

As an embodiment, the algorithm of Equation 5 below may be used instead of Equation 4 as the signature aggregate algorithm.

SigAggregate(pk1,pk2, . . . ,pkn,s1,s2, . . . ,sn)→Result: s [Equation 5]

Here, SigAggregate( ) is an algorithm for generating a single signature based on a plurality of partial signatures, where pki is an ith public key, si is an ith partial signature, and s is a signature obtained as a result value.

That is, the previously generated public keys as input parameters of the signature aggregate algorithm may be additionally input together with partial signatures.

In operation S150, the target data and the signature are transmitted to the external device. The transmitted signature is verified with a verification key in an external device, and when verification is successfully completed, it is considered that the original of the target data has been proved.

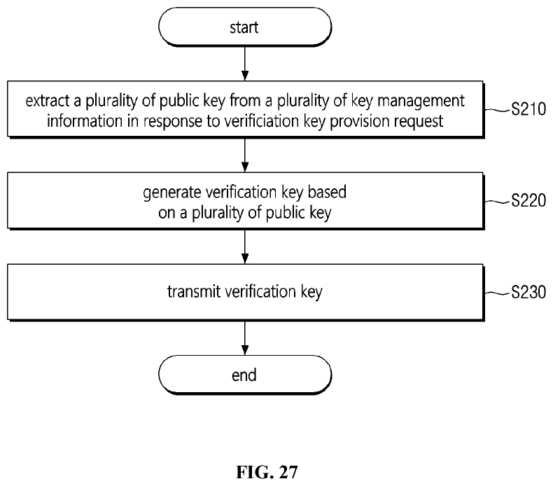

FIG. 27 is a flowchart illustrating an original proving method according to another embodiment of the present disclosure. FIG. 27 illustrates a method for the key management server to generate and provide a verification key for original proof. Therefore, when the performing subject is omitted in the following operations, it is assumed that the performing subject is the key management server 200C of FIG. 21.

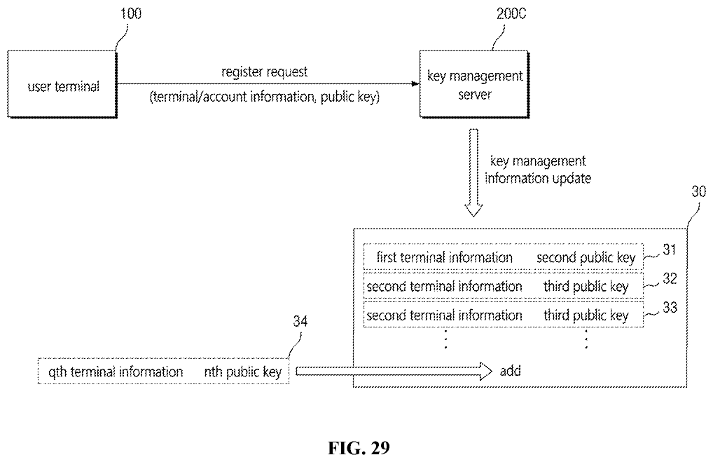

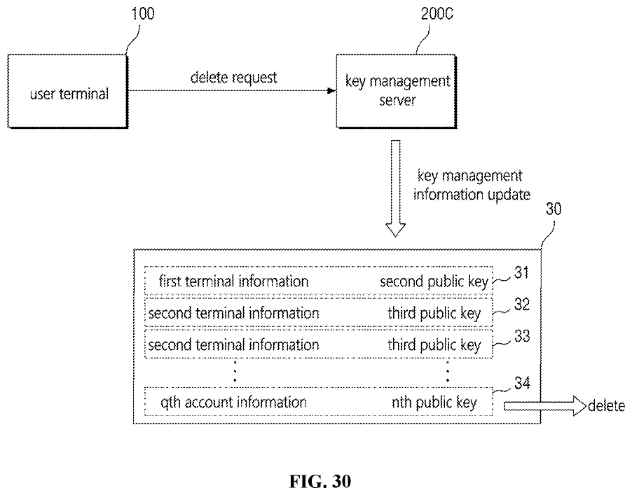

In operation S210, when a verification key provision request is received from the external device, the key management server 200C extracts a plurality of public keys necessary for generating a verification key from a plurality of key management information in response thereto. Here, the key management information is information, in which the public key received from the user terminal is stored together with terminal information or account information corresponding thereto, and the specific form thereof will be described in detail later with reference to FIGS. 29 and 30.

As an embodiment, when a plurality of public keys are extracted from a plurality of key management information, public keys corresponding to the signature generated by the user terminal may be selectively extracted. For example, when the user terminal generates a partial signature based on the first secret key, the third secret key, and the seventh secret key and generates a signature therefrom, a first public key, a third public key, and a seventh public key, which are each paired with the first secret key, the third secret key, and the seventh secret key, may be extracted from a plurality of key management information.

In operation S220, a verification key is generated based on the plurality of extracted public keys. In this case, the verification key may be generated using a public verification key aggregate algorithm as shown in Equation 6.

KeyAggregate(pk1,pk2, . . . ,pkn)→Result: pk [Equation 6]

Here, KeyAggregate( ) is an algorithm for generating a single verification key based on a plurality of public keys, pki is the ith public key, and pk is a verification key obtained as a result value.

In operation S230, the verification key is transmitted from the key management server 200C to the external device 500. The external device verifies the signature transmitted by the user terminal using the transmitted verification key.

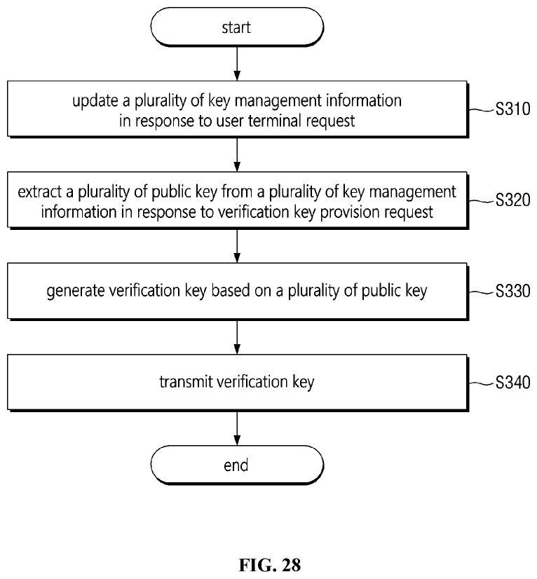

FIG. 28 is a flowchart illustrating an original proving method according to another embodiment of the present disclosure. The embodiment of FIG. 28 is mostly similar to the embodiment of FIG. 27. However, it is different in that operation S310 is added. Operations S320, 5330, and S340 of FIG. 28 are substantially the same as operations S210, S220, and S230 of FIG. 27, respectively. Accordingly, in order to avoid duplication of description, the description of operations S320 to S340 is omitted here.

In operation S310, the key management information stored in the key management server 200C is updated in response to the request of the user terminal 100. For example, when there is a request to add a public key from the user terminal 100, the corresponding public key together with the terminal or account information associated thereto is added to the key management information. Alternatively, when there is a request to delete the public key from the user terminal 100, the corresponding public key and the terminal or account information associated therewith are deleted from the key management information. Here, the associated terminal or account information means information of a terminal or account, in which a secret key paired with the public key is stored.

This will be further described with reference to FIGS. 29 and 30.

FIG. 29 illustrates an embodiment, in which a new public key is added to key management information. First, the user terminal 100 requests registration of a new public key. At this time, the public key and the terminal or account information associated with the public key are transmitted from the user terminal 100. The key management server 200C adds the requested public key and associated terminal or account information to its key management information 30 in response to the request of the user terminal 100. Referring to FIG. 28, an example, in which the nth public key information 34 is added to the existing information 31, 32, and 33 of the key management information 30, is illustrated.

FIG. 30 illustrates an embodiment, in which some public keys are deleted from key management information. First, the user terminal 100 requests deletion of the nth public key. At this time, information on the public key to be deleted is transmitted from the user terminal 100. The key management server 200C deletes the requested public key and associated terminal or account information from its key management information 30 in response to the request of the user terminal 100. Referring to FIG. 30, an example, in which the nth public key information 34 is deleted from the existing information 31, 32, 33, and 34 of the key management information 30, is illustrated.

According to the above embodiments, each public key can be managed more efficiently. For example, when a user adds a new terminal or account for distributed storage of the secret key, or wants to delete a previously registered terminal or account, the corresponding public key and related information may be added or deleted from the key management server by the method of this embodiment. Accordingly, it is possible to manage the public key combination required for generating the public key and the verification key automatically through the key management server without separately managing the public key and associated terminal or account information in the user terminal.

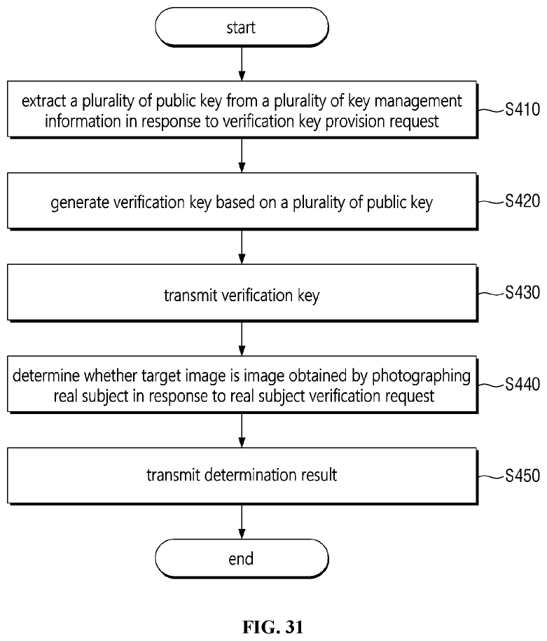

FIG. 31 is a flowchart illustrating an original proving method according to another embodiment of the present disclosure. The embodiment of FIG. 31 is mostly similar to the embodiment of FIG. 27. However, since operations S440 and S450 are added, it is different in that it is determined whether the target image included in the target data is an image obtained by photographing a tangible subject. Operations S410, S420, and S430 of FIG. 31 are substantially the same as operations S210, S220, and S230 of FIG. 26, respectively. Therefore, in order to avoid duplication of description, the description of operations S410 to S430 is omitted here.

In operation S440, when a tangible subject verification request is received from the external device, it is determined whether the target image included in the target data is an image obtained by photographing the tangible subject in response thereto.

In operation S450, the determination result is transmitted to the external device. The external device 500 may determine whether the target data transmitted by the user terminal 100 is an original image or a processed image with reference to the transmitted determination result.

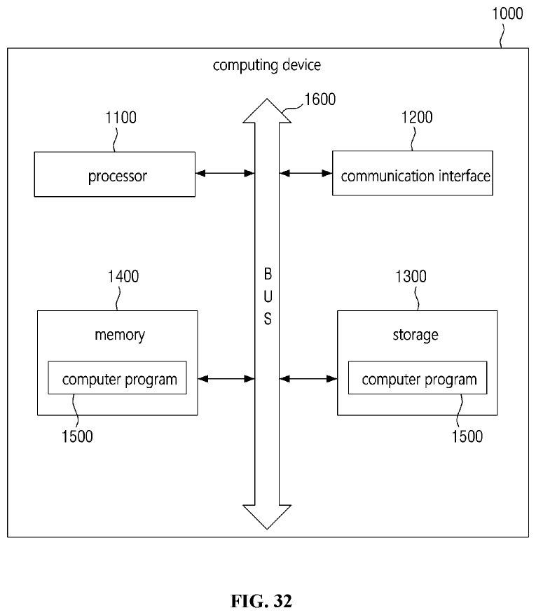

FIG. 32 is a hardware configuration diagram of a computing device according to some embodiments of the present disclosure. The computing device 1000 illustrated in FIG. 31 may indicate, for example, the owner terminal 100 described with reference to FIG. 1. The computing device 1000 may include one or more processors 1100, a system bus 1600, a communication interface 1200, a memory 1400 for loading a computer program 1500 performed by the processor 1100, and a storage 1300 for storing the computer program 1500.

The processor 1100 controls the overall operation of each component of the simulation device 200. The processor 1100 may perform an operation on at least one application or program for executing the method/operation according to various embodiments of the present disclosure. The memory 1400 stores various data, commands, and/or information. The memory 1400 may load one or more computer programs 1500 from the storage 1300 to execute methods/operations according to various embodiments of the present disclosure. The storage 1300 may non-temporarily store one or more computer programs 1500. The computer program 1500 may include one or more instructions, in which methods/operations according to various embodiments of the present disclosure are implemented. When the computer program 1500 is loaded into the memory 1400, the processor 1100 may execute the one or more instructions to perform methods/operations according to various embodiments of the present disclosure.

The computer program 1500 may include instructions for performing, for example, automatically generating an original certificate of non-digital asset data.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method performed by a computing device for generating Non-Fungible Token (NFT) for a non-digital asset, the method comprising:
receiving non-digital asset data comprising additional information and media data generated by photographing the non-digital asset;
determining whether the media data is generated by photographing a tangible subject;
automatically generating an original certificate of non-digital asset data, the original certificate comprising the media data and a result of the determining of whether the media data is generated by photographing the tangible subject; and
issuing an NFT for the original certificate.

2. The method of claim 1, wherein the media data is generated by operations comprising;
obtaining a screen division value for photographing the non-digital asset;
classifying a photographing screen into a plurality of sections based on the screen division value;
photographing a first image by focusing on a first section among the plurality of sections;
photographing a second image by focusing on a second section among the plurality of sections; and
storing both the first image and the second image, as the media data.

3. The method of claim 1, wherein the determining whether the media data is generated by photographing the tangible subject comprises:
obtaining a screen division value related to an image of the non-digital asset;
identifying focused sections of both the first image and the second image with reference to the screen division value; and
determining whether the media data is an image of photographing the tangible subject based on a result of the identified focused sections.

4. The method of claim 1, wherein the automatically generating the original certificate comprises:
converting the additional information into a standard format;
generating hash data of the media data; and
generating hash data of the original certificate using the hash data of the media data and the additional information converted into the standard format.

5. The method of claim 4, wherein the issuing the NFT for the original certificate comprises:
issuing the NFT for the original certificate using the hash data of the original certificate.

6. The method of claim 1, wherein the automatically generating the original certificate comprises:
sending a digital signature request to each terminal of a plurality of owners included in the additional information;
receiving signature data from the each terminal of the plurality of owners;
generating one collective signature data using the received signature data; and
digitally signing the original certificate using the one collective signature data, and
wherein the issuing the NFT for the original certificate comprises:
issuing the NFT for the digitally signed original certificate.

7. The method of claim 6, wherein sending the digital signature request comprises:
sending a digital signature request comprising hash data of the automatically generated original certificate.

8. The method of claim 1 further comprises:
verifying the signed original certificate,
wherein the verifying the signed original certificate comprises:
if there are a plurality of owners of the non-digital asset,
extracting a plurality of public keys of the plurality of owners in response to a verification key provision request; and
generating a single verification key based on the plurality of public keys.

9. The method of claim 8, wherein the plurality of public keys correspond to a plurality of secret keys of the plurality of owners,
wherein the single verification key is used to verify the signed original certificate.

10. The method of claim 1, wherein the automatically generating the original certificate further comprises:
receiving digital signature data for the original certificate from a terminal of an owner;
using the digital signature data to generate a digitally signed original certificate;
generating hash data of the digitally signed original certificate; and
automatically storing the digitally signed original certificate in a cloud storage, and obtaining from the cloud storage, an access path to the original certificate.

11. The method of claim 10, wherein issuing the NFT for the original certificate comprises:
using the hash data of the original certificate and the access path to generate a blockchain transaction for issuing the NFT.

12. A computing device, comprising:
one or more processors;
a memory configured to load a computer program executed by the processor; and
a storage configured to store the computer program,
wherein the computer program includes instructions for performing operations of:
receiving non-digital asset data comprising additional information and media data generated by photographing non-digital asset;
determining whether the media data is generated by photographing a tangible subject;
automatically generating an original certificate of the non-digital asset data, the original certificate comprising a result of the determining of whether media data is generated by photographing the tangible subject data; and
issuing a Non-Fungible Token (NFT) for the original certificate.

13. The computing device of claim 12, wherein the instructions for performing operations further include:
generating the media data, the generating including:
obtaining a screen division value for photographing the non-digital asset;
classifying a photographing screen into a plurality of sections based on the screen division value;
photographing a first image by focusing on a first section among the plurality of sections;
photographing a second image by focusing on a second section among the plurality of sections; and
storing the both first image and the second image as the media data.

14. The computing device of claim 12, wherein the operation of determining whether the media data is generated by photographing the tangible subject includes operations of:
obtaining a screen division value related to an image of the non-digital asset;
identifying focused sections of the both first image and the second image with reference to the screen division value; and
determining whether the media data is an image of photographing a tangible subject based on a result of identifying the identified focused sections.

15. The computing device of claim 12, wherein the operation of automatically generating the original certificate includes operations of:
converting the additional information into a standard format;
generating hash data of the media data; and
generating hash data of the original certificate using the hash data of the media data and the additional information converted into the standard format.

16. The computing device of claim 15, wherein the operation of issuing the NFT for the original certificate includes an operation of:
issuing the NFT for the original certificate using the hash data of the original certificate.

17. The computing device of claim 12, wherein the operation of automatically generating the original certificate includes operations of:
Sending a digital signature request to each terminal of a plurality of owners included in the additional information;
receiving signature data from the each terminal of the plurality of owners;
generating one collective signature data using the received signature data; and
digitally signing the original certificate using the one collective signature data, and
wherein the operation of issuing the NFT for the original certificate includes an operation of:
issuing the NFT for the digitally signed original certificate.

18. The computing device of claim 17, wherein the operation of sending the digital signature request includes an operation of:
sending the digital signature request comprising hash data of the automatically generated original certificate.

19. The computing device of claim 12, wherein the instructions for performing operations further include:
verifying the signed original certificate,
wherein the operation of verifying the signed original certificate includes operations of:
if there are a plurality of owners of the non-digital asset,
extracting a plurality of public keys of the plurality of owners in response to a verification key provision request; and
generating a single verification key based on the plurality of public keys.

20. The computing device of claim 19, wherein the plurality of public keys correspond to a plurality of secret keys of the plurality of owners, and
wherein the single verification key is used to verify the signed original certificate.
